(19) United States
(12) Patent Application Publication
(10) Pub. No.: US 2006/0207907 A1
(43) Pub. Date: Sep. 21, 2006

(54) Beverage container having a display

(76) Inventor: Brian G. Meehan, Bridgeport, CT (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/194,043

(22) Filed: Jul. 29, 2005

Related U.S. Application Data
(60) Provisional application No. 60/662,626, filed on Mar. 16, 2005.

(51) Int. Cl. B65D 85/00; G01K 1/02; B65D 25/10; G04B 47/00; G01K 1/14

(52) U.S. Cl. 206/459.1; 220/710.5; 116/216; 368/10; 374/141; 374/157

(57) ABSTRACT

A beverage container combines the normal utility of a mug that stores and transports substances such as a liquid, with a display means that exhibits information such as time, temperature, messages and a combination thereof. The beverage container comprises a container body having a protruding portion with a recess, a display arranged in the recess, and a cover for coupling to the protruding portion for providing an air- and liquid-tight seal around the display. The display, which is for displaying at least a time or a temperature, is heat resistant and protected by the cover and the seal so that the container can be safely cleaned in a dishwasher without adversely impacting the functions of the display.

### CROSS REFERENCE TO RELATED APPLICATIONS

This application claims priority to a provisional patent application Ser. No. 60/662,626 filed in the U.S. patent and Trademark Office on Mar. 16, 2005. It is incorporated by reference in its entirety. Also incorporated by reference is the subject matter shown and described in a design patent application Ser. No. 29/224,724 filed in the U.S. patent and Trademark Office on Mar. 4, 2005.

### FILED OF THE INVENTION

This invention relates to beverage containers, and more particularly, to beverage containers in combination with timepieces or other information display means.

### DESCRIPTION OF THE RELATED ART

It is well known to use a mug for drinking hot liquids. It is also well known to carry a timepiece, such as a wristwatch. However, some people prefer to not wear a wristwatch sometimes for various reasons. Instead, such people rely upon other timepieces to learn what time it is. Unfortunately, a person who does not wear a wristwatch may not be in an environment where other timepieces are always present. Thus, the person may be late for appointments, etc.

It is also known that a mug having an insulated body may contain a very hot liquid inside and still allow a human hand to hold it comfortably. Sometimes a person drinking the liquid may underestimate the temperature of the liquid and the hot liquid may cause bums to the drinker's mouth or other body parts.

### SUMMARY OF THE INVENTION

The present invention solves the problem of insufficient clocks in the environment of a person who prefers to not wear a watch, and the problem of not knowing the temperature of the liquid in a mug. This is accomplished by combining a mug together with a display such as a timepiece or a thermometer.

The beverage container of the present invention comprises a container body having a protruding portion with a recess, a display arranged in the recess, and a cover for coupling to the protruding portion for providing an air- and liquid-tight seal around the display. The display is for displaying at least a time or a temperature. The display is heat resistant and protected by the cover and the seal so that the container can be safely cleaned in a dishwasher without adversely impacting the functions of the display.

### BRIEF DESCRIPTION OF THE DRAWINGS

The present invention will become more fully understood from the detailed description given hereinafter, and from the accompanying drawings which are given by way of illustration only and thus are not limitative of the present invention, and wherein:

FIG. 1 is a perspective view of a beverage container having a timepiece and a cover shown in an exploded view, according to the present invention;

FIG. 2 is a perspective view of a beverage container having a timepiece and a cover fully assembled on the container, according to the present invention;

FIG. 3 is a front view thereof;

FIG. 4 is a top view thereof;

FIG. 5 is a bottom view thereof

FIG. 6 is a side view thereof; and

FIG. 7 is a rear view thereof.

### DESCRIPTION OF THE INVENTION

The invention is described in detail by way of preferred embodiments.

Throughout this application, the words “mug” and “container” are synonymously used in a broad sense to indicate cups, coffee tumblers, thermoses, and the like.

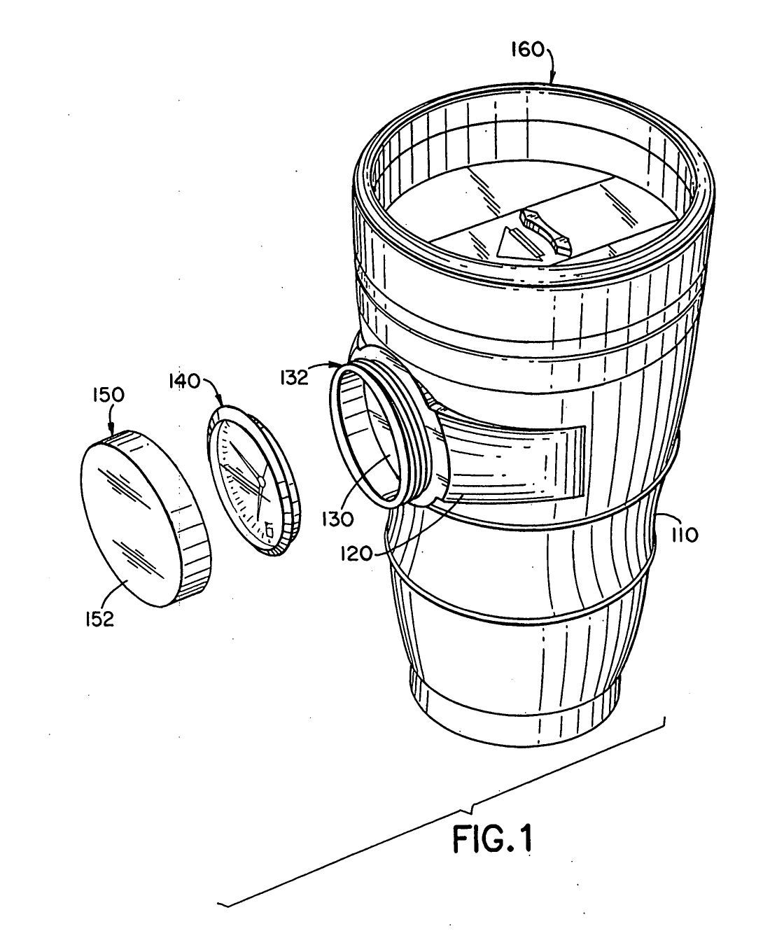

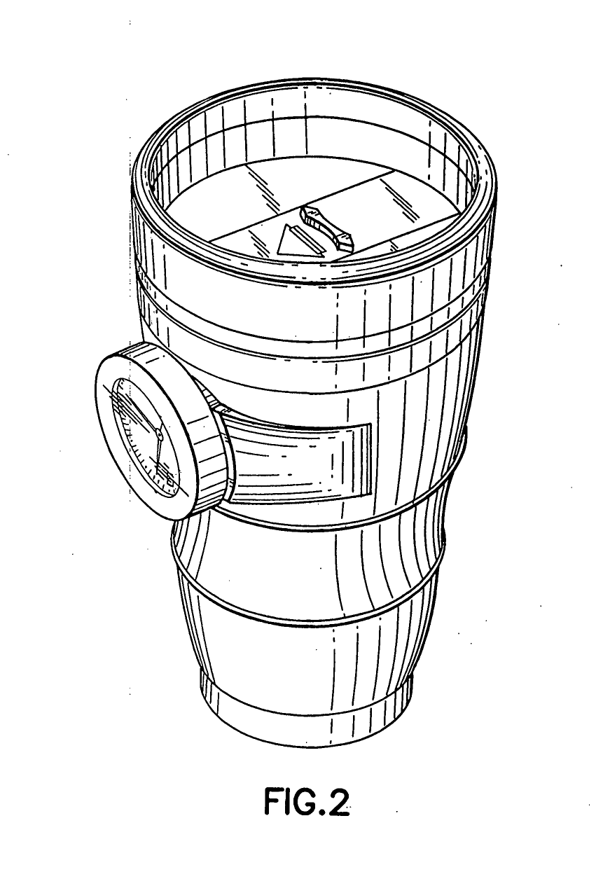

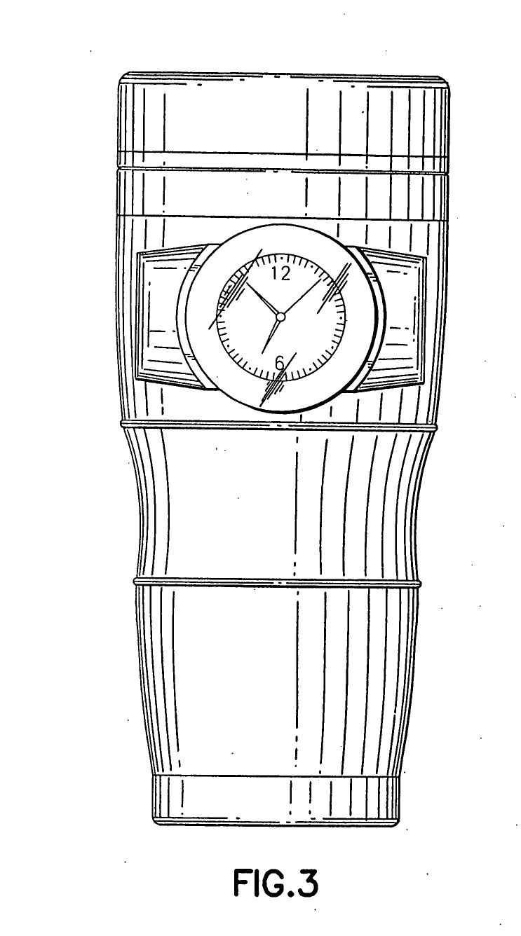

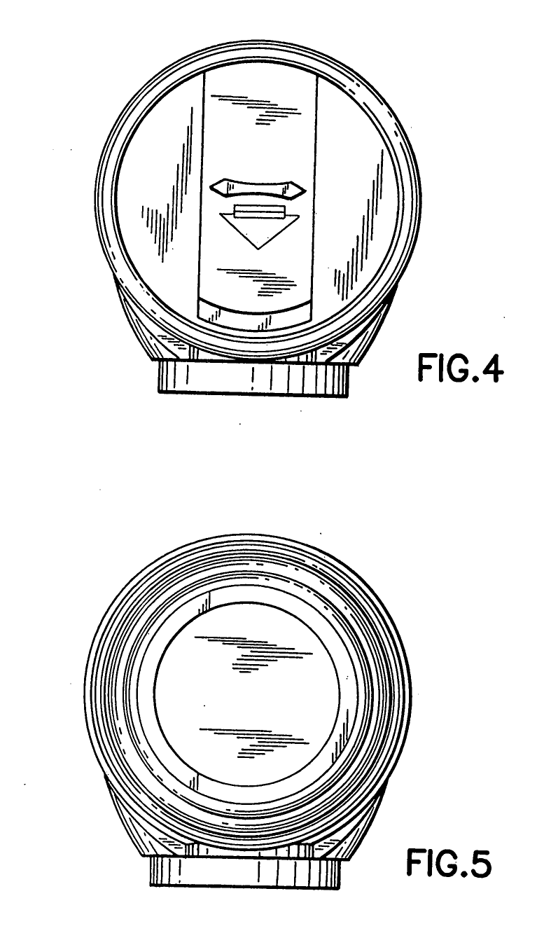

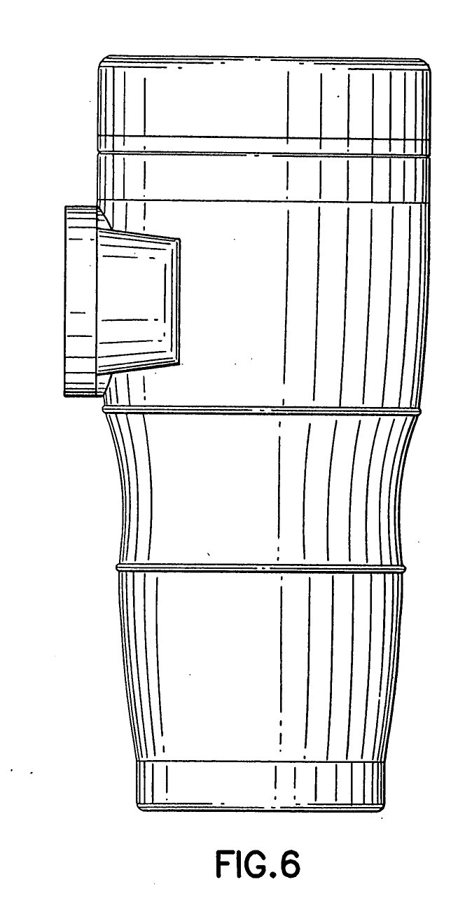

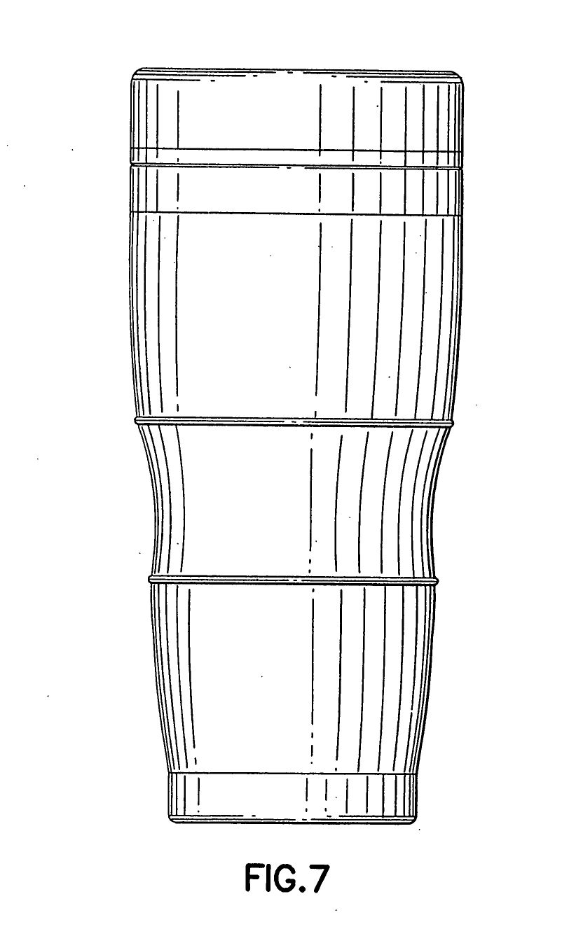

In a first and preferred embodiment of the invention, a beverage container incorporating a timepiece is provided. FIGS. 1-8 show different views of the container. As seen in FIG. 1, the beverage container includes a container body 110 having an inner surface and an outer surface. The outer surface has a protruding portion 120 forming a circular recessed opening 130 with outer threads 132 formed thereon. The recessed opening 130 is adapted for receiving and arranging therein a timepiece 140, such as a battery powered quartz clock. A cover piece 150 having a clear face 152 and corresponding inner threads is rotatably coupled to the threads 132 outside the circular recess 130. When both threads are fully engaged, an air- and water-tight seal is provided for sealing the timepiece 140 so as to withstand water pressure, for example, from a standard dishwasher, and for allowing the display of the timepiece to be read through the clear face 152. The timepiece is also able to withstand temperatures normally observed in a standard dishwasher. Such timepieces are known in the art and the scope of the invention is not intended to be limited to any particular type or kind thereof.

The beverage container further comprises a lid 160 coupled to the open end of the container body.

In a second embodiment of the invention, a beverage container incorporating a timepiece is provided. The beverage container includes a container body having an inner surface and an outer surface. The outer surface has a protruding portion forming a circular recessed opening with an outer locking pattern formed thereon. The recessed opening is adapted for receiving and arranging a timepiece therein. A cover piece having a clear face and corresponding inner locking pattern is coupled to the locking pattern outside the circular recess. When the locking patterns are fully engaged, an air- and water-tight seal is provided for sealing the timepiece so as to withstand water pressure, for example, from a standard dishwasher, and for allowing the display of the timepiece to be read through the clear face. For a better seal, an insulation means such as an 0-ring may be added to the locking mechanism. Locking and sealing mechanisms are known to persons skilled in the art, and the scope of the invention is not intended to be limited to any particular type or kind thereof.

In a third embodiment of the invention, a beverage container incorporating a thermometer is provided. The beverage container includes a container body having an inner surface and an outer surface. The outer surface of the container has a protruding portion forming a circular recessed opening with outer threads or an outer locking pattern formed thereon. The recessed opening is adapted for receiving and arranging a thermometer therein. A temperature sensor of the thermometer is arranged in close proximity to the inner surface of the container to measure a temperature equivalent to that of the contents in the container. A cover piece having a clear face and corresponding inner threads or an inner locking pattern is coupled to the threads or the locking pattern outside the circular recess. When the cover piece and the protruding portion are fully coupled, an air- and water-tight seal is provided for sealing the thermometer so as to withstand water pressure, for example, from a standard dishwasher, and for allowing the display of the temperature to be read through the clear face. The thermometer is also able to withstand temperatures normally observed in a standard dishwasher. Such thermometers are known in the art and the scope of the invention is not intended to be limited to any particular type or kind thereof.

A Dishwasher Compatibility Test has been conducted by an independent testing laboratory (Specialized Technology Resources (H.K.) LTD.) on the products made according to the invention. The criteria of the Dishwasher Compatibility Test are that the sample tested shall withstand 10 repeated cycles of dishwashing at HOT setting without any appreciable change in color and coating, and shall not result in any chipping or adverse effects. Six prototype containers, with display means arranged therein, and with rotatably coupled seals engaged according to the first embodiment of the invention, were tested. The test report concludes that all of the samples withstood repeated cycles of dishwashing as per testing criteria and complied with the requirements of the Dishwasher Compatibility Test.

The scope of the invention is not intended to be limited to any particular way to provide the watertight seal for the display means using rotatable coupling between the cover piece and the protruding portion. The scope of the invention is also not intended to be limited to rotatably coupling the cover piece and the protruding portion, because alternative embodiments are envisioned using a snap fit with or without a suitable O-ring or the like. A person skilled in the art would appreciate how to implement other type of watertight couplings after reading that shown and described herein.

Further, the scope of the invention is not intended to be limited to any particular display means, whether dynamic or still. For example, the display means can exhibit information such as time, temperature, humidity, text message, etc. or any combinations thereof.

It should be understood that, unless stated otherwise herein, any of the features, characteristics, alternatives or modifications described regarding a particular embodiment herein may also be applied, used, or incorporated with any other embodiments described herein.

Although the invention has been described and illustrated with respect to exemplary embodiments thereof, the foregoing and various other additions and omissions may be made therein without departing from the spirit and scope of the present invention, and the appended claims are intended to cover such modifications and arrangements.

What is claimed is:

1. A beverage container, comprising:
a container body having an open end, a closed end, an inner surface and an outer surface, said outer surface having a protruding portion with a recess in the protruding portion;
a display arranged in the recess;
a cover for coupling to the protruding portion for providing an air- and liquid-tight seal around the display,
wherein the display is for displaying at least a time or a temperature, and wherein the display is heat resistant and is further protected by the cover and the seal to withstand conditions in a dishwasher.

2. The beverage container according to claim 1, wherein the protruding portion has outer threads and the cover has corresponding inner threads, and the cover is rotatably coupled to the protruding portion so as to cover the recess.

3. The beverage container according to claim 1, wherein the protruding portion has an outer locking pattern and the cover has a corresponding inner locking pattern, and the cover is locked to the protruding portion so as to cover the recess.

4. The beverage container according to claim 3, further comprising an o-ring arranged between the outer locking pattern and the inner locking pattern.

5. The beverage container according to claim 1, wherein the protruding portion extends in at least two directions from the recess, for providing stability to the recess.

6. The beverage container according to claim 5, wherein the at least two directions include substantially opposite directions.

7. The beverage container according to claim 1, wherein the display means comprises a clock.

8. The beverage container according to claim 7, wherein the clock has a digital display.

9. The beverage container according to claim 7, wherein the clock has an analog display.

10. The beverage container according to claim 1, wherein the display means comprises a thermometer.

11. The beverage container according to claim 10, wherein the thermometer measures and displays temperature of contents in the container.

12. The beverage container according to claim 10, wherein the thermometer has a digital display.

13. The beverage container according to claim 10, wherein the thermometer has an analog display.

14. The beverage container according to claim 1, wherein the display means comprises a thermometer in combination with a clock.

15. The beverage container according to claim 1, wherein the display means is capable of displaying time, temperature, text message and combinations thereof.

16. The beverage container according to claim 1, further comprising a lid coupled to the open end of the container body.

17. A coffee mug, comprising:
a mug body having an open end, a closed end, an inner surface and an outer surface, said outer surface having a protruding portion with a recess in the protruding portion; said protruding portion having outer threads;
a timepiece arranged in the recess;
a cover having corresponding inner threads, for rotatably coupling to the outer threads of the protruding portion and for providing an air- and liquid-tight seal around the timepiece,
wherein the timepiece is customizable for displaying time and messages, and wherein the timepiece is heat resistant and is further protected by the cover and the seal to withstand typical conditions in a dishwasher.

18. The coffee mug according to claim 17, further comprising a lid coupled to the open end of the mug body.
